(19) United States
(12) Patent Application Publication
(10) Pub. No.: US 2012/0317576 A1
(43) Pub. Date: Dec. 13, 2012

(54) method for operating an arithmetic unit

(76) Inventors: Bernd Mueller, Leonberg (DE); Markus Ferch, Grossbottwar (DE); Yorck Von Collani, Beilstein (DE); Holger Banski, Palo Alto, CA (US)

(21) Appl. No.: 13/516,313

(22) PCT Filed: Dec. 2, 2010
(86) PCT No.: PCT/EP2010/068720

§ 371 Date: Aug. 28, 2012

(30) Foreign Application Priority Data
Dec. 15, 2009 (DE) 10 2009 054 637.5

(51) Int. Cl. G06F 9/46

(52) U.S. Cl. 718/102

(57) ABSTRACT

A method for operating an arithmetic unit having at least two computation cores. One signature register which has multiple inputs is assigned in each case to at least two of the at least two computation cores. At least one task is executed by the at least two of the at least two computation cores, an algorithm is computed in each task, results computed by each computation core are written into the assigned signature register, and the results written into the signature registers are compared.

### FIELD OF THE INVENTION

The present invention relates to a method for operating an arithmetic unit, an arithmetic unit, a computer program, and a computer program product.

### BACKGROUND INFORMATION

Various methods are believed to be understood for increasing the security of an electronic control system or an electronic control device which may be used in a vehicle, for example. In addition to matching methods or voting methods, in which the result of a computation is formed by a majority decision, there are also comparative methods in which the results from two arithmetic units are compared to one another, and in the event of a difference the control device is switched off. In the latter case it must be assumed that in any case the control device is in a secure state when it is switched off. Hardware is additionally used in previous comparative methods. The arithmetic units whose results are to be compared operate with a defined, constant clock offset, i.e., synchronously. An additional comparator logic system compares all data which leave the arithmetic units via a network configured as a bus, with a possible clock offset being taken into account.

### SUMMARY OF THE INVENTION

Against this background, a method and an arithmetic unit having the features of the independent patent claims as well as a computer program and a computer program product having the features of the other independent patent claims are presented. Further embodiments of the present invention result from the dependent patent claims and the description.

With the aid of the exemplary embodiments and/or exemplary methods of the present invention, among other things an asynchronous comparison of at least two multiple input shift registers (MISR) or MIS registers or multiple input signature registers, and accordingly, of at least two signature registers having multiple inputs, is provided.

Within the scope of the exemplary embodiments and/or exemplary methods of the present invention, it is provided that a task or a process is started in each case on at least two of at least two computation cores or processors, usually two computation cores, of the arithmetic unit, in one specific embodiment both tasks computing the same algorithm and storing intermediate results using the associated MISR. The contents of the at least two MISRs, which are associated with the at least two tasks, are subsequently compared. The at least two of the at least two computation cores, which may also be referred to as cores, and on which the tasks are computed, are generally not precisely synchronized.

The arithmetic unit includes multiple components, i.e., the at least two computation cores, which are configured to execute tasks, typically redundantly. The tasks are usually software tasks. The signature registers are provided as further components of the arithmetic unit, at least two of the at least two computation cores being associated with these types of signature registers. In addition, the arithmetic unit may have hardware modules, for example target hardware or memory cells. Functions of the components are implemented, among other ways, by executing tasks. Within the scope of the exemplary embodiments and/or exemplary methods of the present invention, the tasks include application tasks, comparison tasks, and write tasks, for example.

For a dedicated comparator logic system having a defined, constant clock offset, it is provided that the at least two of the at least two computation cores generally process the same program code. Temporary parallel processing of different programs is typically not carried out. The performance of such a system corresponds to that of a single-processor system. If there is the option for temporarily switching off a comparator or a comparator system, for example in a DCSL system having a switchover device for switching between an operating mode and a comparison mode, the computation cores or processors must be laboriously synchronized in order to switch them back into comparison mode.

In one embodiment, the present invention described herein allows the comparison of redundantly computed variables without the computation cores having to operate synchronously, i.e., with a constant clock offset. No dedicated comparator logic system which is connected to the computation cores is used. Instead, the comparison operators contained in the at least two of the at least two computation cores are used for this purpose. The method does not check the correctness of all results, usually intermediate results, but, rather, only the particularly relevant results. To minimize the number of variables to be compared, two multiple input shift registers (MISR) are used.

The arithmetic unit according to the present invention is configured to carry out all steps of the presented method. Individual steps of this method may also be carried out by individual components of the arithmetic unit. In addition, functions of the arithmetic unit or functions of individual components of the arithmetic unit may be implemented as steps of the method. Furthermore, it is possible to implement steps of the method as functions of at least one component of the arithmetic unit or of the overall arithmetic unit.

Moreover, the exemplary embodiments and/or exemplary methods of the present invention relate to a computer program having a program code arrangement having program code for carrying out all steps of a described method when the computer program is executed on a computer, in particular in an arithmetic unit according to the present invention.

The computer program product according to the present invention, having a program code arrangement having program code that is stored on a computer-readable data carrier, is configured for carrying out all steps of a described method when the computer program is executed on a computer, in particular in an arithmetic unit according to the present invention.

Further advantages and embodiments of the present invention result from the description and the appended drawings.

It is understood that the features stated above and to be explained below may be used not only in the particular stated combination, but also in other combinations or alone without departing from the scope of the present invention.

### BRIEF DESCRIPTION OF THE DRAWINGS

FIG. 1 shows a schematic illustration of a first specific embodiment of an arithmetic unit according to the present invention for carrying out a first specific embodiment of the method according to the present invention.

FIG. 2 shows a schematic illustration of a second specific embodiment of an arithmetic unit according to the present invention for carrying out a second specific embodiment of the method according to the present invention.

FIG. 3 shows a schematic illustration of a third specific embodiment of an arithmetic unit according to the present invention for carrying out a third specific embodiment of the method according to the present invention.

### DETAILED DESCRIPTION

The exemplary embodiments and/or exemplary methods of the present invention are schematically illustrated in the drawings based on specific embodiments and described in greater detail below with reference to the drawings.

The figures are described in an interrelated and all-encompassing manner, with identical components being denoted by the same reference numerals.

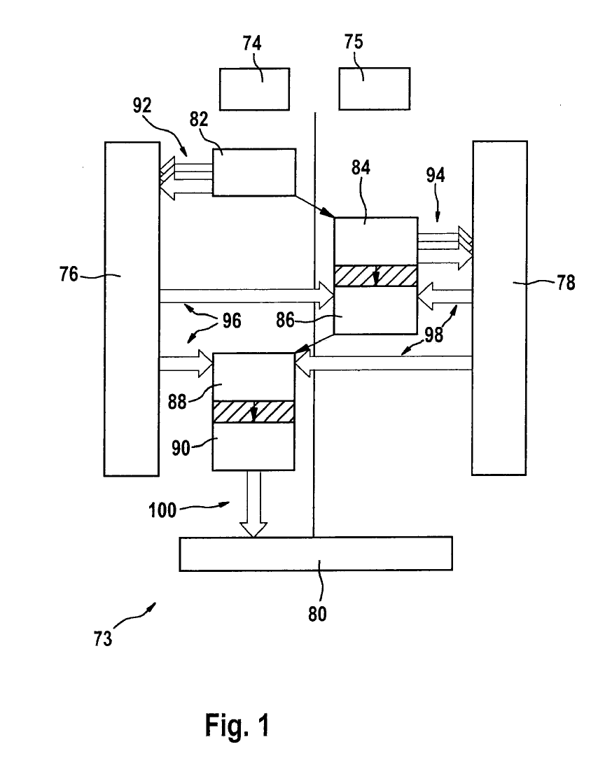

A first specific embodiment of an arithmetic unit 73 according to the present invention for carrying out a first specific embodiment of a method according to the present invention is schematically illustrated in FIG. 1. This arithmetic unit 73 includes a first computation core 74 (core₀) to which a first signature register 76 having multiple inputs (MISR₀) is assigned, a second computation core 75 to which a second signature register 78 having multiple inputs (MISR₁) is assigned, and target hardware 80.

This first specific embodiment relates to a method in which no synchronization points, for example barriers, are used. The time dependencies are ensured here by starting multiple tasks 82, 84, 86, 88, 90 in a predefined sequence. Each task activates its own follow-up task. In this and the subsequent specific embodiments, it is provided that the values of the signature registers (multiple input shift registers (MISR)) are part of the task context, and may be secured or recreated when tasks 82, 84, 86, 88, 90 are changed. Tasks 82, 84, 86, 88, 90 used are linked to the particular computation core 74, 75, and therefore are executed only on that computation core.

Initially, a first task 82, i.e., an application task A₀, is activated in a first step on first computation core 74 (core₀) and executed by the operating system. During the execution an algorithm is processed in application task A₀, and the application developer writes defined results 92, i.e., intermediate and final results, into first signature register 76 MISR₀. After all results 92 have been computed and all intermediate and final results have been written into the MISR, a second task 84, in the present case an application task A₁, is activated on second computation core 75 (core₁).

Results 94 are now likewise computed in application task A₁ in a second step. The algorithm used may be the same as or different from that in first task 82 (application task A₀). In this regard, it is critical that the same results 94 are computed, and the same intermediate and final results are written into second signature register 78. Thus, the manner in which results 94 are computed is not important. When all results 94 have been computed and all relevant intermediate and final results have been written into second signature register 78 (MISR₁), a comparator task B₁ is activated on second computation core 75 (core₁) as third task 86.

In a third step, the values of the two MISRs are read and compared in comparator task B₁ as third task 86. Only when a check confirms that the contents match is a comparator task B₀ activated on first computation core 74 (core₀) as third task 88. In all other cases, an appropriate error correction is carried out, and in particular fourth task 88 as comparator or follow-up task B₀ is not activated or started.

Values 96, 98 of the two MISRs are likewise read and compared in comparator task B₀ in a fourth step. Only when a check confirms that the contents match is a write task C₀ activated on first computation core 74 (core₀) as fifth task 90. In all other cases, an appropriate error correction is carried out, and write task C₀ as a follow-up task is usually not activated or started.

Fifth task 90 (write task C₀) writes computed results 100 on target hardware 80 in a fifth step.

Thus, the comparison of the two MISRs by third task 86 (comparator task B₁) and by fourth task 88 (comparator task B₀) is carried out redundantly to prevent or find errors in computation cores 74, 75. If one of computation cores 74, 75 misinterprets the comparison of the two signature registers 76, 78 in the event that the contents of these signature registers are different, for example, but this difference is not recognized because of an error, the writing operations of the respective other computation core 74, 75 on target hardware 80 by fifth task 90 (write task C₀) are prevented due to the fact that the processing chain has previously been interrupted by the error.

In one variant of the first specific embodiment, tasks A₁ and B₁ as well as tasks B₀ and C₀ in each case may be combined into one task when the sequence of the code to be executed is maintained. Whether single tasks or combined tasks are more meaningful depends on the application, the scheduling, and the run time of the tasks. A decision in this regard may be made on a case-by-case basis, thus allowing the scheduling to be optimized.

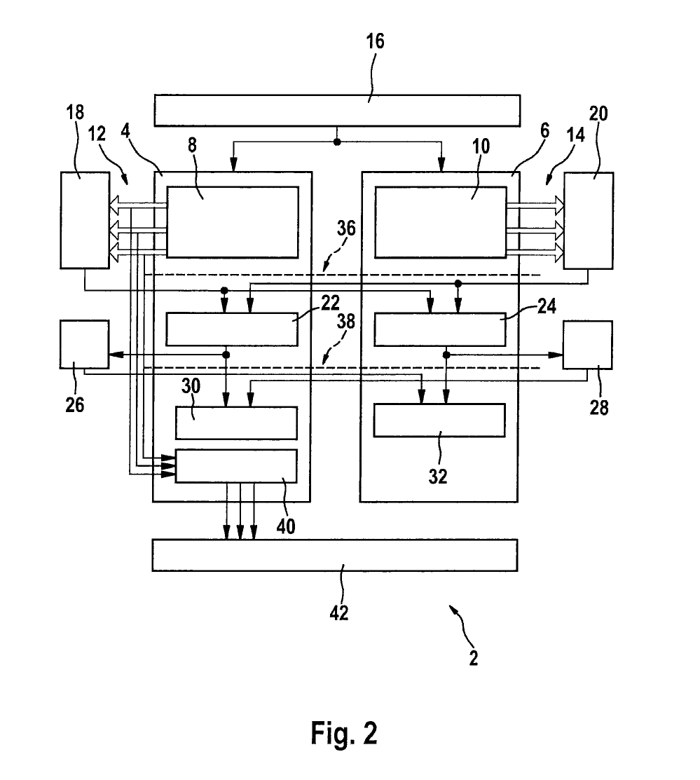

In the second specific embodiment of the method for operating an arithmetic unit 2 shown with reference to FIG. 2, for security reasons it is provided in a first step to carry out a computation redundantly on two computation cores 4, 6 or cores. Two tasks 8, 10, i.e., tasks T_{W} and T_{R}, each of which is linked to one of the two computation cores 4, 6 (C_{W} and C_{R}), i.e., processors, are activated in real time. With appropriate assistance from operating system 16 it is possible to assign the same priority to the tasks. If it is necessary for priority reasons for only one of the tasks to initially start and for the second task to wait, this is acceptable. Precise synchrony is not necessary.

An algorithm is initially computed in each task 8, 10 in a second step. Results 12, 14, i.e., relevant intermediate results and all relevant end results, are written into one signature register 18, 20 which includes multiple inputs (MISR). In one specific embodiment, an application developer determines which results 12, 14 are written into the MISR. Which results 12, 14 and/or which types of results 12, 14 are written into the particular signature register 18, 20 are thus defined. Thus, an individual signature register 18, 20 is associated with each computation core 4, 6, and is initialized when task 8, 10 starts. If the task, i.e., task 8, 10, is interrupted by another task which likewise operates redundantly and likewise uses the MISR, under certain circumstances the MISR together with the context of a task 8, may be stored, and later restored, with the aid of operating system 16.

After all computations have been completed, a synchronization 36 of tasks 8, 10 takes place in a third step, for example with the aid of a so-called barrier. This ensures that both tasks have completed their computations.

The contents of the two MISRs are compared in a fourth step. In the normal case, these contents must be the same. Each task writes the result of comparison 22, 24 into a separate memory cell 26, 28, which may be configured as a local RAM, depending on the architecture.

Within the scope of a check 30, 32 in each case, the tasks compare their comparison results in a subsequent fifth step. For this purpose, synchronization 38 is carried out for the tasks. With the aid of this measure it may be determined whether the comparison operation in one of the computation cores 4, 6 is faulty. If this is the case, a difference in signature registers 18, 20 may be disregarded.

A writing operation 40 is carried out in a final step, first task 8 T_{W} writing the relevant data from first computation core 4 C_{W} on target hardware 42.

Synchronizations 36, 38, which are necessary here, may be implemented with the aid of a barrier or reciprocal event mechanisms, for example according to the OSEK operating system standard for open systems and their interfaces for the electronic system in the motor vehicle.

In one embodiment, an expanded MISR may also be used for synchronization 36, 38 of tasks 8, 10, i.e., applications T_{W} and T_{R}. For this purpose, the MISR is expanded by an additional register in which the number of values written into the MISR is counted. This expanded functionality may be implemented completely as hardware. The same as for the content of the MISR, this counting register is also initialized, and restored with a value. For the synchronization, after one pass, tasks T_{W} and T_{R} may check the value of their own counting register against the value of the counting register of the respective other MISR. If the value of the other counting register corresponds to the value of the task's own counting register, the processing may be continued. Alternatively, an expected value may also be predefined, and a current value checked against it.

In the event of an error, comparison errors may be recognized at two spots, namely, during the comparison of the MISRs in the fourth step and/or during the comparison of the comparison results in the fifth step.

In both cases there is the option of terminating further processing with the aid of a suitable mechanism. The manner in which this takes place generally depends on the security requirements of the application.

In a first variant of the described second specific embodiment, the two tasks 8, 10, i.e., tasks T_{W} and T_{R}, compute different algorithms which, however, are to provide the same result. Accordingly, only values which are the same in both algorithms may be written into the MISRs. This allows the use of various types of software, and allows software errors to be found. In addition, the number of values that may be written into the MISR is reduced, although rounding errors must be taken into account in the results.

In a second variant of the second specific embodiment, the writing of the result into memory cell 26, 28 (RAM) may be dispensed with. In the case of comparison error, when tasks 8, supply different values, the comparison is terminated on both computation cores 4, 6, with an appropriate error correction. To implement this type of behavior, the comparison operation on the second core is likewise terminated regardless of its comparison test, which may be carried out, for example, via time assurance of a synchronization point. As a result, no writing operations take place on target hardware 42.

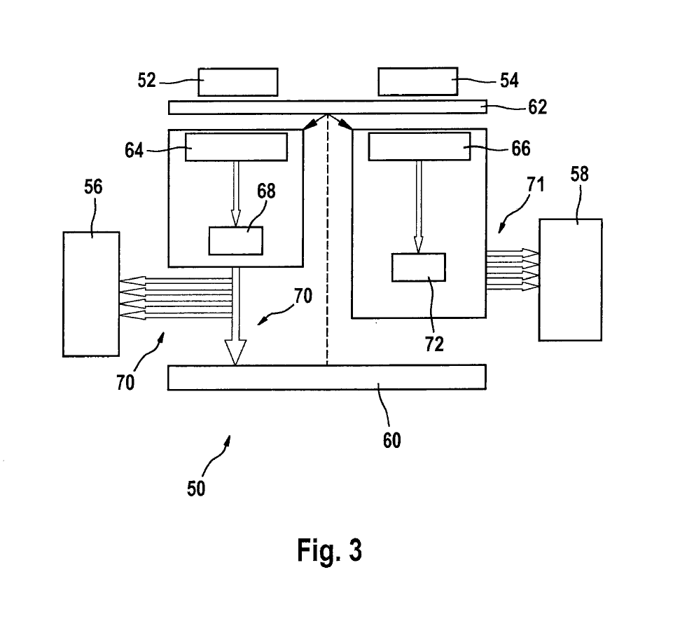

In the third specific embodiment of the method according to the present invention for operating an arithmetic unit 50 schematically illustrated in FIG. 3, it is provided that a brief faulty effect on the hardware is accepted on the system level. As a result, compared to the second specific embodiment, most of the synchronization barriers are dispensed with, and therefore a higher average performance level and a weaker coupling of the two cores are achieved.

FIG. 3 schematically shows a basic design of the third specific embodiment of arithmetic unit 50 according to the present invention. This arithmetic unit 50 includes a first computation core 52 configured as CPU1, and a second computation core 54 configured as CPU2, one signature register 56, 58 having multiple inputs being assigned to each computation core 52, 54, respectively. In addition, FIG. 3 shows target hardware 60 and an operating system (OS) 62 of arithmetic unit 50. Here as well, operating system 62 starts two tasks 64, 66 or applications at the same time or at approximately the same points in time.

The same as in the second specific embodiment, the operating system structure plays no role here; i.e., the method is implementable regardless of whether one operating system 62 or multiple operating systems 62 is/are provided. In this case, however, in a writing operation 68 the first of the two computation cores 52 or cores writes its results 70 and intermediate results, without prior comparison, directly on target hardware 60, which for the case of an error also applies for erroneous results 70. Results 71 of a writing operation 72 of second task 66 are written only into second signature register 58. In addition, it is ensured that at least the relevant intermediate results are written not only on target hardware 60, but also into first signature register 56 (MISR).

There are multiple options in this regard. Writing operation 72 may be implemented in the software, for example, as a separate write instruction. However, it is also possible to design the hardware in such a way that a branch is introduced into the write path, and the hardware therefore carries out the write instruction at two locations simultaneously, or at least in a way that is transparent to the software. This branch may be switched on and off via a control command. This means that the branch is switched on for each intermediate result when the intermediate result is to be written into the MISR. Thus, the software requires only one instruction for writing.

Second computation core 54 (core) receives the same task 66, but in the second computation core all appropriate write instructions are supplied only to assigned signature register (MISR).

Thus, the two computation cores 52, 54 do not compute exactly the same thing, since they have different write characteristics. However, the difference may be automated, and is typically generated by an offline tool (OLT) or an appropriate tool.

Carrying out the comparison operation includes subvariants or options of the specific embodiment described with reference to FIG. 3, the subvariants being arbitrarily combinable with one another.

In a first option it is possible to use the comparison operation in task 64, 66 itself. In this case, after the last writing into the MISR, each of the two tasks 64, 66 waits until the hardware or optionally the software provides a signal to tasks 64, 66 which provides information that the respective other MISR result is also present. In order for the MISRs to know when the last result has been written, either the software sends a signal to the MISR on each core involved, or before the first value is written the particular software signals to the particular MISR how many values are to be written. The task is reactivated upon receipt of this signal, carries out the comparison, outputs the appropriate error responses as applicable, and is then terminated.

In a second option it is provided that for the comparison, an independent comparison task is set on each computation core 52, 54. These tasks are started by the particular task to be monitored, and are able to carry out the comparison as soon as the MISR value of the other core is available.

A third option involves providing a hardware comparator in arithmetic unit 50. This comparator is able to read the MIS registers, for example automatically. Typically, however, the MIS register is provided to the comparator by the task itself, which may be at the end of the tasks. This may also be achieved with the aid of an OLT.

It is generally ensured that the comparison operation is even carried out on both computation cores 52, 54, regardless of the subvariant. For this purpose, time monitoring, for example via a timer, is typically used. The time between the last write instruction into the MISR and the termination of the comparison operation is delimited. To this end, the timer is started after the MISR was finally written into. Accordingly, the time monitoring defines a value for the length of a time interval within which the comparison operation is to be terminated. If the time interval expires before the comparison has been carried out, an error is detected.

In the specific embodiments of the method according to the present invention described here, it is possible that a computation core 4, 6, 52, 54, 74, 75 may go into an infinite loop or be prematurely ended or terminated for other reasons, for example due to unauthorized access of protected memory cells. This type of error may be recognized with the aid of a time condition at all locations at which tasks 8, 10, 64, 66, 88, 90 are synchronized. Computation core 4, 6, 52, 54, 74, 75, which is the first to reach a synchronization point, waits there only for a finite period of time. If the time is exceeded without the respective other computation core 4, 6, 52, 54, 74, 75 likewise reaching the synchronization point, an error is triggered. In this type of run time monitoring, it is taken into account that tasks 8, 10, 64, 66, 82, 84, 86, 88, 90 which are waited on may possibly be interrupted, thus influencing their total run time. Either a deadline is ascertained which is long enough to take all possible interruptions into account, or the time measurement on first computation core 4, 6, 52, 54, 74, 75 is interrupted when something other than the corresponding task is computed on second computation core 4, 6, 52, 54, 74, 75.

The present invention may be used for all control units for which certain security requirements must be met, for example multicore systems or devices which already have multiple arithmetic units that are similar but independent.

1-10. (canceled)

11. A method for operating an arithmetic unit having at least two computation cores, the method comprising:
assigning one signature register, which has multiple inputs, in each case to at least two of the at least two computation cores, in which at least one task is executed by two of the computation cores;
computing an algorithm in each of the tasks;
writing results computed by each computation core into the assigned signature register; and
comparing the results written into the signature registers;
wherein the tasks are started in a predefined sequence, a first task configured as an application task being executed by each computation core and in each case activating at least one second, subsequent task configured as a comparator task, and values of the two signature registers being compared in each task configured as a comparator task.

12. The method of claim 11, wherein the results written into the signature registers compared by the tasks.

13. The method of claim 11, wherein it is provided that the algorithms are to deliver the same results in a computation, the same algorithm being computed by the at least two of the at least two computation cores, and/or different algorithms being computed by the at least two of the at least two computation cores.

14. The method of claim 11, wherein at least two tasks are synchronized with one another.

15. The method of claim 11, wherein comparison results are written into a separate memory cell by each task, and the comparison results are compared to one another.

16. The method of claim 11, wherein the signature registers are signaled when the last result is written, the signature registers being sent a signal by the software on each computation core involved, or, before a first result is written, the particular signature register being signaled by the particular software as to how many values are to be written.

17. An arithmetic unit, comprising:
at least two computation cores, one signature register which has multiple inputs being assigned in each case to at least two of the at least two computation cores, two of the computation cores being configured to execute at least one task, to compute an algorithm in each task, and to write computed results into the assigned signature register; and
at least one component of the arithmetic unit being configured to compare the results written into the signature registers;
wherein the tasks are started in a predefined sequence, each computation core executing a first task which is configured as an application task, and which in each case activates at least one second, subsequent task which is configured as a comparator task, each task configured as a comparator task comparing values of the two signature registers.

18. The arithmetic unit of claim 17, wherein the computation cores have comparison operators which are configured to compare the results.

19. A computer readable medium having a computer program, which is executable by a processor, comprising:
a program code arrangement having program code for operating an arithmetic unit having at least two computation cores, by performing the following:
assigning one signature register, which has multiple inputs, in each case to at least two of the at least two computation cores, in which at least one task is executed by two of the computation cores;
computing an algorithm in each of the tasks;
writing results computed by each computation core into the assigned signature register; and
comparing the results written into the signature registers;
wherein the tasks are started in a predefined sequence, a first task configured as an application task being executed by each computation core and in each case activating at least one second, subsequent task configured as a comparator task, and values of the two signature registers being compared in each task configured as a comparator task.
